(19) United States
(12) Patent Application Publication
(10) Pub. No.: US 2026/0152631 A1
(43) Pub. Date: Jun. 4, 2026

(54) POLYPROPYLENE COMPOSITION WITH GOOD SEALING PROPERTIES

(71) Applicant: Basell Poliolefine Italia S.r.l., Milano (IT)

(72) Inventors: Monica Galvan, Ferrara (IT); Michele Grazzi, Ferrara (IT); Marco Clarafoni, Ferrara (IT); Alessia Di Capua, Ferrara (IT); Lelio Basile, Ferrara (IT); Eleonora Ciaccia, Ferrara (IT)

(73) Assignee: Basell Poliolefine Italia S.r.l., Milano (IT)

(21) Appl. No.: 19/122,206

(22) PCT Filed: Oct. 11, 2023
(86) PCT No.: PCT/EP2023/078199

§ 371 Date: Apr. 17, 2025

(30) Foreign Application Priority Data
Oct. 20, 2022 (EP) 22202645.2

(51) Int. Cl. C08L 23/14; B32B 27/08; B32B 27/32

(52) U.S. Cl. CPC C08L 23/142; B32B 27/08; B32B 27/32; B32B 2250/242; B32B 2307/518; C08L 2203/16; C08L 2205/025; C08L 2205/035

(57) ABSTRACT

A polypropylene composition (I) made from or containing:
(A) at least 90 wt. % of a propylene polymer made from or containing:
   (a) 20-44 wt. % of a propylene-hexene copolymer,
   (b) 25-45 wt. % of a propylene-hexene-ethylene terpolymer
   (c) 25-50 wt. % of a propylene-ethylene copolymer;
   wherein
      the Melt Flow Rate of components (a)+(b)+(c) ranges from 3.5 to 12.0 g/10 min;
      the xylene soluble content of the propylene polymer (A) ranges from 13.0 to 25.0% by weight, and
      the melting point of the propylene polymer (A) ranges from 122° C. to 132° C., and
(B) up to and including 10.0% by weight of a polybutene,
wherein the amounts of (A) and (B) are based on the total weight of (A)+(B).

### FIELD OF THE INVENTION

In general, the present disclosure relates to the field of chemistry. More specifically, the present disclosure relates to polymer chemistry. In particular, the present disclosure relates to a polypropylene composition made from or containing (A) a propylene polymer made from or containing a copolymer of propylene with 1-hexene, a propylene-ethylene-hexene terpolymer and a copolymer of propylene with ethylene and (B) a polybutene, and films made therefrom.

### BACKGROUND OF THE INVENTION

In some instances, copolymers of propylene and 1-hexene have a monomodal molecular weight distribution and are used for pipe systems.

In some instances, a composition made from or containing a copolymer of propylene with 1-hexene and a copolymer of propylene and ethylene is used for films, including biaxially oriented polypropylene films (BOPP) and cast films having a low seal initiation temperature (SIT) and high transparency.

In some instances, films have external sealing layers made from or containing blends of polypropylene and polybutene-1.

In some instances, a multilayer film has a sealing layer made from or containing a polybutene-1, containing 2.1 mol. % of ethylene, and a propylene-butene-ethylene terpolymer.

In some instances, a multilayer film has a sealing layer made from or containing butene-1 homo or copolymers and propylene copolymers with hexene-1.

### SUMMARY OF THE INVENTION

In a general embodiment, the present disclosure provides a polypropylene composition (I) made from or containing:
(A) at least 90.0% by weight of a propylene polymer made from or containing (based on the weight of (a)+(b)+(c), the weight being 100%):
(a) from 20% to 44% by weight of a propylene-hexene copolymer having (ai) from 5.0% to 8.3% by weight of hexene derived units, based on the weight of component (a), and (aii) a Melt Flow Rate (MFR(a)), measured according to ISO 1133-1:2011 (230° C./2.16 kg), ranging from 3.5 to 8.5 g/10 min;
(b) from 25% to 45% by weight of a propylene-hexene-ethylene terpolymer having (bi) from 7.2% to 12.0% by weight of hexene derived units and (bii) from 0.5% to 2.5% by weight of ethylene derived units, based on the weight of component (b), wherein the Melt Flow Rate (MFR(a+b)) of components a)+b), measured according to ISO 1133-1:2011 (230° C./2.16 kg), ranges from 3.5 to 8.5 g/10 min; and
(c) from 25% to 50% by weight of a propylene-ethylene copolymer having from 3.5% to 8.7% by weight of ethylene derived units, based on the weight of component (c),
wherein the Melt Flow Rate of components (a)+(b)+(c), measured according to ISO 1133-1:2011, (230° C./2.16 kg) ranges from 3.5 to 12.0 g/10 min, and
wherein the propylene polymer (A) has:
(Ai) a xylene soluble content at 25° C. ranging from 13.0% to 25.0% by weight, based on the weight of (a)+(b)+(c); and
(Aii) a melting point ranging from 122° C. to 132° C.; and
(B) up to and including 10.0% by weight of a polybutene selected from the group consisting of butene homopolymers, butene copolymers having up to and including 5.0% by weight of units derived from ethylene, propylene, or both, based on the weight of component (B), and mixtures thereof,
wherein the amounts of (A) and (B) are based on the total weight of (A)+(B), the total weight being 100%.

In some embodiments, the polypropylene composition (I) is used for producing films or sheets.

In some embodiments, the present disclosure provides a film or a sheet made from or containing the polypropylene composition (I).

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, the total weight of a polymer composition sums up to 100%, unless otherwise specified.

In the present disclosure, when the term “comprising” is referred to a polymer, a plastic material, a polymer composition, mixture or blend, the term should be construed to mean “comprising or consisting essentially of”.

In the present disclosure, the term “consisting essentially of” means that, in addition to the specified components, the plastic material, the polymer composition, the polymer mixture, or the polymer blend may be further made from or containing other components, provided that the characteristics of the material are not materially affected by the presence of the other components. In some embodiments, the other components are selected from the group consisting of catalyst residues, antistatic agents, processing aids, melt stabilizers, light stabilizers, antioxidants and antiacids.

In the present disclosure, the term “copolymer” is referred to a polymer deriving from the intentional polymerization of two different comonomers, that is, the term “copolymer” does not include terpolymers.

In the present disclosure, the term “terpolymer” is referred to a polymer deriving from the intentional polymerization of three different comonomers.

In the present disclosure, the term “hexene” refers to hexene-1. In the present disclosure, the term “butene” refers to butene-1. In the present disclosure, the term “polybutene” refers to polymers of butene-1.

In the present disclosure, the term “film” refers to a thin layer of material having thickness equal to or lower than 2000 μm.

In the present disclosure, the term “sheet” refers to a layer of material more than 2000 μm thick.

In the present disclosure, the term “skin layer” is referred to an outermost layer of a multilayer film.

In the present disclosure, the term “base layer” is referred to the innermost layer of a multilayer film.

In some embodiments, the present disclosure provides a polypropylene composition (I) made from or containing:
at least 90.0% by weight, alternatively from 90.0% to 99.5% by weight, alternatively from 93.0% to 99.0% by weight, alternatively from 95.0% to 98.0% by weight, of the propylene polymer (A), and
up to and including 10.0% by weight, alternatively from 0.5% to 10.0% by weight, alternatively from 1.0% to 7.0% by weight, alternatively from 2.0% to 5.0% by weight, of the polybutene (B),
wherein the amounts of (A) and (B) are based on the total weight of (A)+(B), the total being 100%.

In some embodiments, the polypropylene composition (I) is made from or containing the individual components in various combinations.

In some embodiments, the propylene polymer (A) is made from or containing (based on the weight of (a)+(b)+(c), the weight being 100%):
(a) from 20% to 44% by weight, alternatively from 27% to 40% by weight, alternatively from 29% to 35% by weight, of a propylene-hexene copolymer, based on the weight of the component (a) having (ai) from 5.0% to 8.3% by weight, alternatively from 6.3% to 7.8% by weight, alternatively from 6.5% to 7.4% by weight, of hexene derived units, based on the weight of component (a), and (aii) a Melt Flow Rate (MFR(a)), measured according to ISO 1133-1:2011 (230° C./2.16 kg), ranging from 3.5 to 12.0 g/10 min, alternatively from 3.5 to 8.5 g/10 min, alternatively from 4.4 to 8.0 g/10 min, alternatively from 5.0 to 7.0 g/10 min;
(b) from 25% to 45% by weight, alternatively from 35% to 40% by weight, alternatively from 36% to 39% by weight, of a propylene-hexene-ethylene terpolymer having (bi) from 7.2% to 12.0% by weight, alternatively from 7.5% to 9.5% by weight, alternatively from 8.2% to 9.1% by weight, of hexene derived units and (bii) from 0.5% to 2.5% by weight, alternatively from 0.7% to 2.2% by weight, alternatively from 0.8% to 2.0% by weight, of ethylene derived units, based on the weight of component (b),
   wherein the Melt Flow Rate of components a)+b) (MFR(a+b)), measured according to ISO 1133-1:2011 (230° C./2.16 kg), ranges from 3.5 to 8.5 g/10 min, alternatively from 4.4 to 8.0 g/10 min, alternatively from 5.0 to 7.0 g/10 min; and
(c) from 25% to 50% by weight, alternatively from 27% to 40% by weight, alternatively from 29% to 35% by weight, of a propylene-ethylene copolymer having from 3.5% to 8.7% by weight, alternatively from 4.5% to 8.4% by weight, of ethylene derived units, based on the weight of component (c),
   wherein the Melt Flow Rate of components (a)+(b)+(c), measured according to ISO 1133-1:2011, (230° C./2.16 kg), ranges from 3.5 to 12.0 g/10 min, alternatively from 4.4 to 8.0 g/10 min, alternatively ranging from 5.0 to 8.5 g/10 min, and
wherein the propylene polymer (A) has:
(Ai) a xylene soluble content at 25° C. ranging from 13.0% to 25.0% by weight, alternatively from 14.0% to 23.0% by weight, alternatively from 15.0% to 20.0% by weight, based on the weight of (a)+(b)+(c); and
(Aii) a melting point ranging from 122° C. to 132° C., alternatively from 125° C. to 131° C., alternatively from 126° C. to 130° C.

In some embodiments, the propylene polymer (A) is a reactor blend of components (a), (b) and (c). In some embodiments, the process for preparing the propylene polymer (A) is carried out in the presence of a highly stereospecific heterogeneous Ziegler-Natta catalyst. In some embodiments, the Ziegler-Natta catalysts are made from or containing a solid catalyst component made from or containing a titanium compound having a titanium-halogen bond and an electron-donor compound (internal donor), both supported on magnesium chloride. In some embodiments, the Ziegler-Natta catalysts systems are further made from or containing an organo-aluminum compound as a co-catalyst and optionally an external electron-donor compound.

In some embodiments, the catalysts systems are as described in the European Patent Nos. EP45977, EP361494, EP728769, and EP 1272533 and Patent Cooperation Treaty Publication No. W000163261.

In some embodiments, the organo-aluminum compound is an alkyl-Al compound. In some embodiments, the alkyl-Al compound is selected from trialkyl aluminum compounds. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, mixtures of trialkylaluminums with alkylaluminum halides, alkylaluminum hydrides, or alkylaluminum sesquichlorides are used. In some embodiments, alkylaluminum sesquichlorides are selected from the group consisting of AlEt₂Cl and Al₂Et₃Cl₃.

In some embodiments, external electron-donor compounds are selected from the group consisting of silicon compounds, ethers, esters, amines, heterocyclic compounds, ketones, and 1,3-diethers. In some embodiments, the ester is ethyl 4-ethoxybenzoate. In some embodiments, the heterocyclic compound is 2,2,6,6-tetramethyl piperidine. In some embodiments, the silicon compounds have formula Rₐ⁵R_{b}⁶Si(OR⁷)_{c}, wherein a and b are integers from 0 to 2, c is an integer from 1 to 3, and the sum (a+b+c) is 4; R⁵, R⁶, and R⁷ are alkyl, cycloalkyl or aryl radicals with 1-18 carbon atoms optionally containing heteroatoms. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1, 1, 1, trifluoropropyl-methyl-dimethoxysilane. In some embodiments, the amount of external electron donor compound provides a molar ratio between the organo-aluminum compound and the electron donor compound of from 0.1 to 500; alternatively from 1 to 100; alternatively from 2 to 50.

In some embodiments, the polymerization process is continuous or batch. In some embodiments, the polymerization process is operated in gas phase, in liquid phase, or by mixed liquid-gas techniques. In some embodiments, the liquid phase is operated in the presence of an inert diluent. In some embodiments, the liquid phase is operated in the absence of an inert diluent.

In some embodiments, the polymerization is carried out in gas phase in three reactors, wherein each component prepared in a different reactor. In some embodiments and in the first two reactors, components (a) and (b) are respectively prepared while component (c) is prepared in the third and last reactor.

In some embodiments, the polymerization temperature ranges from 20° C. to 100° C. In some embodiments, the polymerization pressure is atmospheric or higher. In some embodiments, the polymerization pressure is above atmospheric.

In some embodiments, the molecular weight of the components (a), (b) and (c) is regulated. In some embodiments, the molecular weight regulator is hydrogen.

In some embodiments, component (B) is a butene-ethylene copolymer. In some embodiments, component (B) is a butene-ethylene copolymer having at least one of the following properties:
a content of units deriving from ethylene ranging from 1.0% to 4.5% by weight, alternatively from 1.5% to 4.5% by weight, alternatively from 2.0% to 4.0% by weight, alternatively from 2.5% to 3.5% by weight, based on the weight of (B); or
a melting temperature Tm (I) of the form I, measured by DSC according to the method ISO 11357-3:2018, lower than 100° C., alternatively ranging from 80° to lower than 100° C., alternatively from 90° to 97° C.; or
a melt flow rate, measured according to ISO 1133-1:2011 (190° C./2.16 kg), ranging from 1.0 to 6.0 g/10 min., alternatively from 2.0 to 5.0 g/10 min, alternatively from 3.0 to 4.5 g/10 min; or
a flexural modulus, measured according to ISO 178:2010, equal to or higher than 80 MPa, alternatively ranging from 80 to 250 MPa, alternatively from 100 to 210 MPa. In some embodiments, component (B) is a butene-ethylene copolymer having the previously-described properties.

In some embodiments, the butene-ethylene copolymer (B) further has a molecular weight distribution Mw/Mn ranging from 4.0 to 9.0, alternatively from 4.0 to 8.0, alternatively from 4.0 to 7.0, alternatively from more than 4.5 to less than 6.0.

In some embodiments, the polybutene (B) is obtained using a metallocene-based catalyst system.

In some embodiments, the polybutene (B) is obtained by polymerizing the relevant monomers in the presence of a Ziegler-Natta catalyst system.

In some embodiments, the polymerization process is carried out with slurry polymerization using as diluent a liquid inert hydrocarbon. In some embodiments, the polymerization process is carried out with solution polymerization. In some embodiments, liquid butene is used as a reaction medium. In some embodiments, the polymerization process is carried out in the gas-phase, operating in one or more fluidized or mechanically agitated bed reactors. In some embodiments, the polymerization is carried out with solution polymerization using liquid butene as a reaction medium.

In some embodiments, the polymerization is carried out at temperature of from 20° to 120° C., alternatively of from 40° to 90° C. In some embodiments, the polymerization is carried out in one or more reactors. In some embodiments, the reactors are operated under same or different reaction conditions such as concentration of molecular weight regulator, comonomer concentration, temperature, or pressure.

In some embodiments, the catalyst system and polymerization process to obtain the polybutene (B) is as described in Patent Cooperation Treaty Publication No. WO2004/048424A1.

In some embodiments, the polybutene (B) is commercially available. In some embodiments, the polybutene (B) is commercially available under the trade name Toppyl from LyondellBasell.

In some embodiments, the polypropylene composition (I) is further made from or containing up to and including 5.0% by weight, alternatively from 0.01% to 5.0% by weight, of at least one additive (C) selected from the group consisting of nucleating agents, antistatic agents, anti-oxidants, light stabilizers, slipping agents, anti-acids, melt stabilizers, and combinations thereof, the amount of additive being based on the total weight of the polypropylene compositions (I) further made from or containing the additive, the total weight being 100%.

In some embodiments, the polyolefin composition (I) consists of the component (A), the component (B) and optionally an additive (C).

In some embodiments, the polyolefin composition (I) is obtained by mixing the components (A), (B) and optionally (C) in a melt mixing apparatus. In some embodiments, the melt mixing apparatus is a twin screw extruder.

In some embodiments, the SIT, measured on BOPP film, ranges from 70° C. to 85° C., alternatively from 72° C. to 83° C.

In some embodiments, the ΔTm-SIT value (difference between Tm of the polypropylene composition (I) and SIT measured on a BOPP film) ranges from 40.0° C. to 60.0° C., alternatively from 45.0° C. to 55° C.

In some embodiments, the present disclosure provides a film or a sheet made from or containing the polypropylene composition (I) In some embodiments, the film is a cast film or a BOPP film.

In some embodiments, the film or the sheet is single-layer of multilayer. In some embodiments, the film or the sheet is a multilayer film or sheet, wherein a skin layer is made from or containing the polypropylene composition (I). In some embodiments, the film or the sheet is a multilayer film or sheet, wherein both skin layers are made from or containing the polypropylene composition (I).

In some embodiments, the features are not inextricably linked to each other. In some embodiments, ranges of a feature are combined with ranges of a different feature, independently.

### Examples

The following examples are given for illustration without limiting purpose.

### Characterization Methods:

Melt Flow Rate: Determined according to the method ISO 1133-1:2011 (230° C./2.16 kg for the propylene polymers and 190° C./2.16 kg for polybutene).

Solubility in xylene at 25° C. for propylene polymers: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C., with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(I) and XSA values were experimentally determined. The fraction of component (B) soluble in xylene at 25° C. (XSB) was calculated from the formula:

$$XS = W ( A ) \times ( {XS}_{A} ) + W ( B ) \times ( {XS}_{B} )$$

wherein W(A) and W(B) are the relative amounts of components (A) and (B), respectively, and W(A)+W(B)=1.

Hexene content of propylene-hexene copolymers by NMR: ¹³C NMR spectra were acquired on an AV-600 spectrometer, operating at 150.91 MHz in the Fourier transform mode at 120° C. The peak of the propylene CH was used as internal standard at 28.83. The ¹³C NMR spectrum was acquired using the following parameters:

| Spectral width (SW) | 60 ppm |
|---|---|
| Spectrum center (O1) | 30 ppm |
| Decoupling sequence | WALTZ 65_64pl |
| Pulse program | ZGPG |
| Pulse Length (P1) | for 90° |
| Total number of points (TD) | 32K |
| Relaxation Delay | 15 s |
| Number of transients | 1500 |

The total amount of 1-hexene, as molar percent, was calculated from diad using the following relations:

$$[ P ] = PP + 0.5 PH$$

$$[ H ] = HH + 0.5 PH$$

Assignments of the ¹³C NMR spectrum of propylene/1-hexene copolymers were calculated according to the following table:

| Area | Chemical Shift | Assignments | Sequence |
|---|---|---|---|
| 1 | 46.93-46.00 | S_{αα} | PP |
| 2 | 44.50-43.82 | S_{αα} | PH |
| 3 | 41.34-4.23 | S_{αα} | HH |
| 4 | 38.00-37.40 | S_{αγ} + S_{αδ} | PE |
| 5 | 35.70-35.0 | 4B₄ | H |
| 6 | 35.00-34.53 | S_{αγ} + S_{αδ} | HE |
| 7 | 33.75 33.20 | CH | H |
| 8 | 33.24 | T_{δδ} | EPE |
| 9 | 30.92 | T_{βδ} | PPE |
| 10 | 30.76 | S_{γγ} | XEEX |
| 11 | 30.35 | S_{γδ} | XEEE |
| 12 | 29.95 | S_{δδ} | EEE |
| 13 | 29.35 | 3B₄ | H |
| 14 | 28.94-28.38 | CH | P |
| 15 | 27.43-27.27 | S_{βδ} | XEE |
| 16 | 24.67-24.53 | S_{ββ} | XEX |
| 17 | 23.44-23.35 | 2B₄ | H |
| 18 | 21.80-19.90 | CH₃ | P |
| 19 | 14.22 | CH₃ | H |

Ethylene content of propylene-ethylene copolymers by NMR: ¹³C NMR spectra were acquired on a Bruker AV-600 spectrometer equipped with cryoprobe, operating at 160.91 MHz in the Fourier transform mode at 120° C. The peak of the Sββ carbon (nomenclature according to “Monomer Sequence Distribution in Ethylene-Propylene Rubber Measured by 13C NMR. 3. Use of Reaction Probability Mode”, C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz. The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

$$PPP = 100 T ββ / S \qquad PPE = 100 T βδ / S \qquad EPE = 100 T δδ / S$$

$$PEP = 100 S ββ / S \qquad PEE = 100 S βδ / S \qquad EEE = 100 ( 0.25 S γδ + 0.5 S δδ ) / S$$

$$S = T ββ + T βδ + T δδ + S ββ + S βδ + 0.25 S γδ + 0.5 S δδ$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C.J. Carman, R.A. Harrington and C.E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm).

Hexene and ethylene content of propylene-hexene-ethylene terpolymers: ¹³C NMR spectra were acquired on an AV-600 spectrometer, operating at 150.91 MHz in the Fourier transform mode at 120° C. The peak of the propylene CH was used as internal standard at 28.83. The ¹³C NMR spectrum was acquired using the following parameters:
Spectral width (SW): 60 ppm
Spectrum center (01): 30 ppm
Decoupling sequence: WALTZ 65_64pl
Pulse program (1): ZGPG
Pulse Length (P1) (2): for 90°
Total number of points (TD): 32K
Relaxation Delay (2): 15 s
Number of transients (3): 1500

The total amount of 1-hexene and ethylene as molar percent was calculated from diad using the following relations:

$$[ P ] = PP + 0.5 PH + 0.5 PE$$

$$[ H ] = HH + 0.5 PH$$

$$[ E ] = EE + 0.5 PE$$

Assignments of the ¹³C NMR spectrum of propylene/1-hexene/ethylene copolymers were calculated according to the following table:

| Area | Chemical Shift | Assignments | Sequence |
|---|---|---|---|
| 1 | 46.93-46.00 | S_{αα} | PP |
| 2 | 44.50-43.82 | S_{αα} | PH |
| 3 | 41.34-4.23 | S_{αα} | HH |
| 4 | 38.00-37.40 | S_{αγ} + S_{αδ} | PE |
| 5 | 35.70-35.0 | 4B₄ | H |
| 6 | 35.00-34.53 | S_{αγ} + S_{αδ} | HE |
| 7 | 33.75 33.20 | CH | H |
| 8 | 33.24 | T_{δδ} | EPE |
| 9 | 30.92 | T_{βδ} | PPE |
| 10 | 30.76 | S_{γγ} | XEEX |
| 11 | 30.35 | S_{γδ} | XEEE |
| 12 | 29.95 | S_{δδ} | EEE |
| 13 | 29.35 | 3B₄ | H |
| 14 | 28.94-28.38 | CH | P |
| 15 | 27.43-27.27 | S_{βδ} | XEE |
| 16 | 24.67-24.53 | S_{ββ} | XEX |
| 17 | 23.44-23.35 | 2B₄ | H |
| 18 | 21.80-19.90 | CH₃ | P |
| 19 | 14.22 | CH₃ | H |

Comonomer content of polybutene: ¹³C NMR spectra were acquired on a Bruker AV-600 spectrometer equipped with cryoprobe, operating in the Fourier transform mode at 120° C. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing 1H-13C coupling. The spectrometer was operated at 160.91 MHz. The peak of the S88 carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. 512 transients were stored in 32K data points using a spectral window of 9000 Hz.

The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:

$$BBB = 100 {T}_{ββ} / S \qquad BBE = 100 {T}_{βδ} / S \qquad EBE = 100 {P}_{δδ} / S$$

$$BEB = 100 {S}_{ββ} / S \qquad BEE = 100 {S}_{αδ} / S \qquad EEE = 100 ( 0.25 {S}_{γδ} + 0.5 {S}_{δδ} ) / S$$

$$S = {T}_{ββ} + {T}_{βδ} + {P}_{δδ} + {S}_{ββ} + {S}_{αδ} + 0.25 {S}_{γδ} + 0.5 {S}_{δδ}$$

The total amount of 1-butene and ethylene as molar percent was calculated from triad using the following relations:

$$[ E ] = EEE + BEE + BEB$$

$$[ B ] = BBB + BBE + EBE$$

The weight percentage of ethylene content (E % wt) was calculated using the following equation:

$$E \% wt = \frac{[ E ] mol \times MWE}{( [ E ] mol \times MWE ) + ( [ B ] mol \times MWB )} \times 100$$

wherein
[B] mol=the molar percentage of 1-butene content;
MW_{E}=molecular weights of ethylene
MWB=molecular weight of 1-butene.

Molecular weight distribution Mw/Mn: The determination of the means Mn and Mw, and Mw/Mn derived therefrom was carried out using a Waters GPCV 2000 apparatus, which was equipped with a column set of four PLgel Olexis mixed-gel (Polymer Laboratories) and an IR4 infrared detector (PolymerChar). The dimensions of the columns were 300×7.5 mm with particle size 13 μm. The mobile phase used was 1-2-4-trichlorobenzene (TCB) with a flow rate at 1.0 ml/min. The measurements were carried out at 150° C. Solution concentrations were 0.1 g/dl in TCB and 0.1 g/l of 2,6-di-tert-butyl-p-cresole were added, thereby preventing degradation. For GPC calculation, a universal calibration curve was obtained using 10 polystyrene (PS) standard samples supplied by Polymer Laboratories (peak molecular weights ranging from 580 to 8500000). A third order polynomial fit was used to interpolate the experimental data and obtain the calibration curve. Data acquisition and processing were done using Empower (Waters). The Mark-Houwink relationship was used to determine the molecular weight distribution and the relevant average molecular weights: the K values were KPS=1.21×10−4 dL/g and KPB=1.78×10−4 dL/g for PS and PB respectively, while the Mark-Houwink exponents α=0.706 for PS and α=0.725 for PB were used. For butene-1/ethylene copolymers, the composition was assumed constant in the whole range of molecular weights and the K value of the Mark-Houwink relationship was calculated using a linear combination:

$${K}_{EB} = {x}_{E} {K}_{PE} + {x}_{P} {K}_{PB}$$

where K_{EB} was the constant of the copolymer, K_{PE} (4.06×10⁻⁴, dL/g) and K_{PB} (1.78×10⁻⁴ dl/g) were the constants of polyethylene and polybutene and xE and xB were the ethylene and the butene-1 weight % content. The Mark-Houwink exponent α=0.725 was used for the butene-1/ethylene copolymers.

Melting temperature: measured according to the method ISO 11357-3:2018. Polypropylene and polypropylene compositions: scanning rate of 20° C./min in cooling and heating, on a sample weighing 5-7 mg, under nitrogen flow. Instrument calibration was made with Indium. Polybutene: To determine the melting temperature of the polybutene crystalline form I (Tm (I)), the sample was melted, kept at 200° C. for 5 minutes, and then cooled down to 20° C. with a cooling rate of 10° C./min. The sample was then stored for 10 days at room temperature. After 10 days, the sample was subjected to DSC. The sample was cooled to −20° C. and then heated at 200° C. with a scanning speed corresponding to 10° C./min. In this heating run, the first peak temperature coming from the lower temperature side in the thermogram was taken as the melting temperature Tm (I).

Flexural Modulus: determined according to the method ISO 178:2010 on injection molded test specimens (80×10×4 mm) obtained according to the method ISO 1873-2:2007 for propylene polymers or on compression molded specimens for butene polymers. Specimens of butene copolymers were conditioned for 10 days at 23° C. before testing.

Preparation of BOPP film test specimens. Films with thickness of 50 μm were prepared by extruding each test composition in a single screw Collin extruder (length/diameter ratio of screw 1:25) at a film drawing speed of 7 m/min and a melt temperature of 210-250° C. Each film was superimposed on a 1000 μm thick film of a propylene homopolymer, having a xylene insoluble fraction of 97 wt. % and a MFR (ISO1133-1:2011, 230° C./2.16 kg) of 2.0 g/10 min. The superimposed films were bonded to each other in a plat press at 200° C. under a 35 kg×cm² load, which was maintained for 5 minutes. The resulting laminates were simultaneously stretched longitudinally and transversally, that is, biaxially, by a factor 7 with a Karo 4 Brueckener film stretcher at 160° C., thereby obtaining a 20 μm thick BOPP film (18 μm homopolymer+2 μm test composition).

Sealing Initiation Temperature on BOPP films: Film Strips, 6 cm wide and 35 cm length, were cut from the center of the BOPP film. The film was superimposed with a BOPP film made of PP homopolymer. The superimposed specimens were sealed along a 2 cm sides with a Brugger Feinmechanik Sealer, model HSG-ETK 745. Sealing time was 5 seconds at a pressure of 0.14 MPa (20 psi). The starting sealing temperature was from about 10° C. less than the melting temperature of the test composition. The sealed strip was cut into 6 specimens 15 mm wide long enough to be held in the tensile tester grips. The seal strength was tested at a load cell capacity 100 N, cross speed 100 mm/min, and grip distance 50 mm. The results were expressed as the average of maximum seal strength (N). The unsealed ends were attached to an Instron machine, wherein the sample specimens were tested at a traction speed of 50 mm/min.

The test was repeated by changing the temperature as follows:

If seal strength <1.5 N, then increase the temperature.

If seal strength >1.5 N, then decrease the temperature

Temperature variation was adjusted stepwise. If seal strength was close to target, steps of 1° C. were selected. If the strength was far from target, steps of 2° C. were selected.

The target seal strength (SIT) was defined as the lowest temperature at which a seal strength higher or equal to 1.5 N was achieved.

### Raw Materials

Irganox 1010: Pentaerythritol tetrakis(3-(3,5-di-tert-butyl-4-hydroxyphenyl) propionate) commercially available from BASF.

Irgafos 168: tris(2,4-di-tert.-butylphenyl)phosphite commercially available from BASF.

PB1 (B): a copolymer of butene-1 with ethylene, having 3.5% by weight of ethylene, a Tm (I) of 94° C., a molecular weight distribution Mw/Mn of 5.6, a melt flow rate of 3.1 g/10 min. (ISO 1133-1:2011, 190° C./2.16 kg), and a flexural modulus (ISO 178:2010) of 120 MPa. The butene-1 copolymer was obtained by sequential polymerization in two reactors, using butene-1 as liquid medium and a Ziegler-Natta catalyst system according to the Example 11 of the Patent Cooperation Treaty Publication No. WO2004/048424, with the following polymerization conditions of the first reactor: temperature of 75° C. and hydrogen/butene feed ratio of 1000 ppmV. After 2.5 hours, the polymerization content of the first reactor was transferred into the second reactor, where the copolymerization continued under the same conditions with the ethylene feed was discontinued. The polymerization was stopped after 2 hours.

PB2 (B): a copolymer of butene-1 with ethylene, having 3.5% by weight of ethylene, a Tm (I) of 65° C., a molecular weight distribution Mw/Mn of 2.2, a melt flow rate of 3.3 g/10 min. (ISO 1133-1:2011, 190° C./2.16 kg), and a flexural modulus (ISO 178:2010) of 130 MPa.

### Propylene Polymer (A)

Procedure for the preparation of the spherical adduct: microspheroidal MgCl₂·pC₂H₅OH adduct was prepared according to the method described in Comparative Example 5 of Patent Cooperation Treaty Publication No. WO98/44009, with the difference that BiCl₃ in a powder form and in an amount of 3 mol % with respect to the magnesium was added before feeding the oil.

Procedure for the preparation of the solid catalyst component: the solid catalyst component was prepared according to Example 1 of European Patent No. EP728769 with the following differences:
the second and third titanations were carried out at 110° C. (instead of 120° C.); and
MgCl_{2.3}·C₂H₅OH in the form of spherical solid particles with a maximum diameter less than or equal to 65 microns (instead of 50 microns) was used.

Catalyst system and prepolymerization treatment: The solid catalyst component was contacted at 15° C. for about 6 minutes with aluminum triethyl (TEAL) and dicyclopentyl dimethoxy silane (DCPMS) as external donor.

The catalyst system was then subjected to prepolymerization by suspending the catalyst system in liquid propylene at 20° C. for about 20 minutes, before introducing the catalyst system into the polymerization reactor.

Polymerization: Into a first gas phase polymerization reactor, a propylene-hexene copolymer (component (a)) was produced by feeding, in a continuous and constant flow, the prepolymerized catalyst system, hydrogen, propylene and 1-hexene in the gas state. The propylene copolymer produced in the first reactor was discharged, in a continuous flow, and introduced, in a continuous flow, into a second gas phase polymerization reactor, together with quantitatively constant flows of hydrogen, hexene, ethylene and propylene in the gas state. The propylene terpolymer produced in the second reactor was discharged, in a continuous flow, and, after having been purged of unreacted monomers, was introduced, in a continuous flow, into a third gas phase polymerization reactor, together with quantitatively constant flows of hydrogen, hexene and propylene in the gas state. The polymerization conditions are reported in Table 1.

TABLE 1

| | | |
|---|---|---|
| Catalyst feed | g/h | 16 |
| TEAL/solid catalyst | g/g | 3 |
| TEAD/Donor D | g/g | 11 |
| GPR1 | | |
| Temperature | ° C. | 72 |
| Pressure | barg | 15 |
| H2/C3 | mol/mol | 0.0005 |
| C6/C3 + C6 | mol/mol | 0.063 |
| split | | 30 |
| C6# | wt. % | 7.0 |
| MFR# | g/10 min | 6.5 |
| GPR2 | | |
| Temperature | ° C. | 72 |
| Pressure | barg | 15 |
| H2/C3 | mol/mol | 0.009 |
| C6/C3 + C6 | mol/mol | 0.082 |
| C2/C2 + C3 | mol/mol | 0.019 |
| split | | 38 |
| C2# | wt. % | 0.8 |
| C6# | wt. % | 8.2 |
| MFR# | g/10 min | 5.8 |
| GPR3 | | |
| Temperature | ° C. | 65 |
| Pressure | barg | 14 |
| H2/C3 | mol/mol | 0.018 |
| C2/C2 + C3 | mol/mol | 0.053 |
| split | | 32 |
| C2# | wt. % | 2.0 |
| C6# | wt. % | 6.0 |
| MFR# | g/10 min | 5.5 |

H2 = hydrogen; C3 = propylene; C2 = ethylene; C6 = hexene
# values measured on powders exiting the respective reactor

The resulting polymer was further made from or containing 0.05 wt. % of Irganox 1010, 0.1 wt. % of Irgafos 168, and 0.05% of calcium stearate, wherein the amounts of the additives were based on the total weight of the polymer including the additives, and then pelletized. Table 2 illustrates the features of the propylene polymer.

TABLE 2

| Component (a) | | |
|---|---|---|
| split | wt. % | 30 |
| C6(a) | wt. % | 7.0 |
| MFR(a) | g/10 min | 6.5 |
| XS(a) | wt. % | 12.0 |
| Component (b) | | |
| split | wt. % | 38 |
| C6(b)* | wt. % | 9.1 |
| C2(b)* | wt. % | 1.4 |
| MFR(a + b) | g/10 min | 5.8 |
| Component (c) | | |
| split | wt. % | 32 |
| C2(c)* | wt. % | 4.6 |
| Propylene polymer (A) | | |
| C6 | wt. % | 6.0 |
| C2 | wt. % | 2.0 |
| MFR | g/10 min | 5.5 |
| XS | wt. % | 17.4 |
| Tm | ° C. | 127.9 |
| To | ° C. | 83.9 |
| SIT on BOPP | ° C. | 79 |

C2 = ethylene; C6 = hexene
* values calculated with the formulas:
C2(GPR2) = C2(b) × split(GPR2)/split(GPR2 + GPR1)
C2(GPR3) = [C2(GPR2) × split(GPR1 + GPR2)/100] + C2(c) × split(GPR3)/100
C6(GPR2) = [C6(GPR1) × split(GPR1)/split(GPR1 + GPR2)] + [C6(b) × split(GPR2)/split(GPR1 + GPR2)]
wherein
- C2(GPR2) and C2(GPR3) are the amounts of C2 measured on the polymer exiting the GPR2 and GPR3 respectively;
- C6(GPR1) and C6(GPR2) are the amounts of C6 measured on the polymer exiting the GPR1 and GPR2 respectively.

### Examples E1-E3

The propylene polymer (A) and the polybutene (B) were melt blended in the proportions reported in Table 3 in a twin screw extruder (Werner 58, model WP ZSK-58) at a rotation speed of 220 rpm and with an extruder output of 220 kg/hour.

The thermal and sealing properties of the polypropylene composition are reported in Table 3. The polypropylene composition also showed a low fish eye count on cast films.

TABLE 3

| | | E1 | E2 | E3 |
|---|---|---|---|---|
| Polypropylene composition (A) | wt. % | 100 | 97 | 97 |
| PB1 (B) | wt. % | — | 3 | — |
| BP2 (B) | wt. % | — | — | 3 |
| MFR (230° C., 2.16 kg) | g/10 min | 5.5 | 5.3 | 4.7 |
| Tm | ° C. | 127.9 | 127.9 | 128.1 |
| Tc | ° C. | 83.9 | 84.3 | 84.5 |
| XS | wt. % | 17.4 | 19.0 | 18.4 |
| SIT | ° C. | 79 | 74 | 72 |

What is claimed is:

1. A polypropylene composition (I) comprising:
(A) at least 90.0% by weight of a propylene polymer comprising (based on the weight of (a)+(b)+(c)):
(a) from 20% to 44% by weight of a propylene-hexene copolymer having (ai) from 5.0% to 8.3% by weight of hexene derived units, based on the weight of component (a), and (aii) a Melt Flow Rate (MFR(a)), measured according to ISO 1133-1:2011 (230° C./2.16 kg), ranging from 3.5 to 8.5 g/10 min;
(b) from 25% to 45% by weight of a propylene-hexene-ethylene terpolymer having (bi) from 7.2% to 12.0% by weight of hexene derived units and (bii) from 0.5% to 2.5% by weight of ethylene derived units, based on the weight of component (b),
wherein the Melt Flow Rate (MFR(a+b)) of components a)+b), measured according to ISO 1133-1:2011 (230° C./2.16 kg), ranges from 3.5 to 8.5 g/10 min; and
(c) from 25% to 50% by weight of a propylene-ethylene copolymer having from 3.5% to 8.7% by weight of ethylene derived units, based on the weight of component (c),
wherein the Melt Flow Rate of components (a)+(b)+(c), measured according to ISO 1133-1:2011 (230° C./2.16 kg), ranges from 3.5 to 12.0 g/10 min, and wherein the propylene polymer (A) has:
(Ai) a xylene soluble content at 25° C. ranging from 13.0% to 25.0% by weight, based on the weight of (a)+(b)+(c); and
(Aii) a melting point ranging from 122° C. to 132° C.; and
(B) up to and including 10.0% by weight of a polybutene selected from the group consisting of butene homopolymers, butene copolymers having up to and including 5.0% by weight of units derived from ethylene, propylene, or both, based on the weight of component (B), and mixtures thereof,
wherein the amounts of (A) and (B) are based on the total weight of (A)+(B).

2. The polypropylene composition (I) according to claim 1 comprising:
from 90.0% to 99.5% by weight of the propylene polymer (A), and
from 0.5% to 10.0% by weight of the polybutene,
wherein the amounts of (A) and (B) are based on the total weight of (A)+(B).

3. The polypropylene composition (I) according to claim 1, wherein the propylene polymer (A) comprises (based on the weight of (a)+(b)+(c)):
(a) from 27% to 40% by weight of a propylene-hexene copolymer, having
(ai) from 6.3% to 7.8% by weight of hexene derived units, based on the weight of component (a), and
(aii) a Melt Flow Rate (MFR(a)), measured according to ISO 1133-1:2011 (230° C./2.16 kg), ranging from 4.4 to 8.0 g/10 min;
(b) from 35% to 40% by weight of a propylene-hexene-ethylene terpolymer having
(bi) from 7.5% to 9.5% by weight of hexene derived units, and
(bii) from 0.7% to 2.2% by weight of ethylene derived units,
based on the weight of component (b),
wherein
the Melt Flow Rate of components (a)+(b) (MFR(a+b)), measured according to ISO 1133-1:2011 (230° C./2.16 kg), ranging from 3.5 to 8.5 g/10 min and
(c) from 27% to 40% by weight of a propylene-ethylene copolymer having
from 4.5% to 8.4% by weight of ethylene derived units, based on the weight of component (c),
wherein
the Melt Flow Rate of components (a)+(b)+(c), measured according to ISO 1133-1:2011, (230° C./2.16 kg) ranges from 4.4 to 8.0 g/10 min, and
wherein the propylene polymer (A) has:
(Ai) a xylene soluble content at 25° C. ranging from 14.0% to 23.0% by weight, based on the weight of (a)+(b)+(c); and
(Aii) a melting point ranging from 125° C. to 131° C.

4. The polypropylene composition (I) according to claim 1, wherein component (B) is a butene-ethylene copolymer.

5. The polypropylene composition (I) according to claim 4, wherein component (B) is a butene-ethylene copolymer having at least one of the following properties:
a content of units deriving from ethylene ranging from 1.0% to 4.5% by weight, based on the weight of (B); or
a melting temperature Tm (I) of the form I, measured by DSC according to the method ISO 11357-3:2018, lower than 100° C.; or
a melt flow rate, measured according to ISO 1133-1:2011 (190° C./2.16 kg), ranging from 1.0 to 6.0 g/10 min; and/or
a flexural modulus, measured according to ISO 178:2010, equal to or higher than 80 MPa.

6. The polypropylene composition (I) according to claim 1, further comprising up to and including 5.0% by weight of at least one additive (C) selected from the group consisting of nucleating agents, antistatic agents, anti-oxidants, light stabilizers, slipping agents, anti-acids, melt stabilizers, and combinations thereof, the amount of additive being based on the total weight of the polypropylene compositions (I) comprising the additive.

7. The polypropylene composition (I) according to claim 1, having at least one of the following properties:
a Sealing Initiation Temperature (SIT), measured on BOPP films, ranging from 70° C. to 85° C.; or
a ΔTm-SIT value ranging from 40.0° C. to 60.0° C., wherein the Tm is the melting temperature of the polypropylene composition (I) and the SIT is the Sealing Initiation Temperature measured on BOPP film.

8. A film or sheet comprising the polypropylene composition (I) according to claim 1.

9. The film or sheet according to claim 8, wherein the film or sheet is multilayer and has at least one skin layer comprising the polypropylene composition (I).

10. The film or sheet according to claim 8, wherein the film is a cast or a BOPP film.
